(19) United States
(12) Patent Application Publication
(10) Pub. No.: US 2010/0194845 A1
(43) Pub. Date: Aug. 5, 2010

(54) TELEVISION SYSTEM AND CONTROL METHOD THEREOF

(75) Inventors: Dae-woo Cho, Seoul (KR); Chang-young Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/497,881

(22) Filed: Jul. 6, 2009

(30) Foreign Application Priority Data
Feb. 3, 2009 (KR) 10-2009-0008474

(51) Int. Cl. H04N 7/14

(52) U.S. Cl. 348/14.04; 348/E07.077

(57) ABSTRACT

A television system for providing video telephony includes a user input device; and a signal processing apparatus. The user input device includes an image photographing unit which photographs an image of a user; and a voice receiving unit which receives a voice of the user. The signal processing apparatus includes a display unit; a voice output unit; a communication unit which receives an image and a voice of counterpart and transmits the user image and the user voice; a voice processing unit which processes the received counterpart voice and outputs the processed voice to the voice output unit; an image processing unit which includes a first image processing block which processes the received counterpart image; and a controller which processes the user image using a software decoder and controls the image processing unit.

### CROSS-REFERENCE TO RELATED APPLICATION

This application claims priority from Korean Patent Application No. 10-2009-0008474, filed on Feb. 3, 2009 in the Korean Intellectual Property Office, the disclosure of which is incorporated herein by reference in its entirety.

### BACKGROUND OF INVENTION

1. Field of Invention

Apparatuses and methods consistent with the present invention relate to a television system which provides video telephony and a control method thereof.

2. Description of Related Art

A variety of video telephony solutions have been developed as internet data transmission speed has increased. For example, programs such as Skype™, make video telephony available at a low price nearly everywhere in the world. Further, video telephony is expected to be as popular in the near future as current telephone service is at present. Such video communication systems are expected to be applied to various image apparatuses including a terminal such as a vehicle and a display unit.

### SUMMARY OF INVENTION

The present invention provides a television system in which a user performs video telephony while viewing a broadcast, and a control method thereof.

Accordingly, an aspect of the present invention provides a television system which can transmit a good quality voice with echo removed, and a control method thereof.

The foregoing and/or other aspects of the present invention may be achieved by providing a television system including: a user input device; and a signal processing apparatus, the user input device including: an image photographing unit which photographs an image of a user and generates a user image signal; and a voice receiving unit which receives a user voice signal including a voice of the user, and the signal processing apparatus including: a communication unit which receives an image signal and a voice signal of at least one counterpart from an external communication path, and transmits the user image signal and the user voice signal to the counterpart through the external communication path; a voice processing unit which processes the received counterpart voice signal; an image processing unit which includes a first image processing block which processes the received counterpart image signal; a voice output unit which receives the processed counterpart voice signal from the voice processing unit and outputs an counterpart voice; a display unit; and a controller which processes the user image signal using a software decoder, and controls the image processing unit so that the processed user image signal and the counterpart image signal are displayed on the display unit.

The image processing unit may process the counterpart image signal into a first layer and process the user image signal into a second layer which overlaps with the first layer.

The first layer may include a video layer, and the second layer may include a graphic layer.

The user input device may further include a signal synthesizing unit which synchronizes the user image signal and the user voice signal, and the signal processing apparatus may further include a signal separating unit which separates the user image signal from the user voice signal received from the signal synthesizing unit.

The signal processing apparatus may further include: an echo removing unit which removes the counterpart voice from the user voice signal received by the voice receiving unit; and a voice compression unit which compresses the user voice signal output from the echo removing unit and outputs the compressed user voice signal to the communication unit.

The user input device may further include an image compression unit which compresses the user image signal.

The signal processing apparatus may further include a broadcast receiving unit which receives a broadcast signal including an image signal; wherein the image processing unit may further include a second image processing block which processes the image signal in the broadcast signal, and the controller controls the image processing unit so that the broadcast image signal is displayed on the display unit together with the counterpart image signal and the user image signal.

The signal processing apparatus may further include a broadcasting receiving unit which receives a broadcast signal including a voice signal, wherein the controller prevents the voice signal in the broadcast signal from being output to the voice output unit if at least one of an image signal and a voice signal is received from the communication unit or the user input device.

The broadcast signal may further include the image signal, the image processing unit may further include a second image processing block which processes the image signal in the broadcast signal, and the controller controls the second image processing block so that the image signal in the broadcast signal is not displayed on the display unit if at least one of the image signal and the voice signal is received from the communication unit or the user input device.

The user input device and the signal processing apparatus are connected by a USB interface.

Still another aspect of the present invention may be achieved by providing a control method of a television system which may include an image photographing unit which photographs a user's image and generates a user image signal; a voice receiving unit which receives a user's voice and generates a user voice signal; a display unit; and a voice output unit, where the control method includes: compressing the user image signal; processing a received voice signal of at least one counterpart; processing the compressed user image signal and the user voice signal for transmission to an external communication path; processing a received image signal of the counterpart using a hardware decoder; processing the user image signal using a software decoder; synthesizing the processed user image signal and the counterpart image signal and displaying the synthesized image signals on the display unit, and outputting the processed counterpart voice signal to the voice output unit.

The counterpart image signal is processed into a first layer and the user image signal is processed into a second layer which overlaps with the first layer, to be displayed on the display unit.

The first layer may include a video layer, and the second layer comprises a graphic layer.

The transmitting the user voice signal to an external communication path may include removing the counterpart voice from a voice signal received from the voice receiving unit.

The television system may further include a broadcast receiving unit which receives a broadcast signal including an image signal, the method further including: processing the image signal in the broadcast signal using a hardware decoder different from the hardware decoder which processes the counterpart image signal, and displaying the image signal in the broadcast signal on the display unit together with the counterpart image signal and the user image signal.

The television system may further include a broadcast receiving unit which receives a broadcast signal including a voice signal, the method further including preventing the voice signal in the broadcast signal from being output to the voice output unit if at least one of the image signal and the voice signal is received from the communication unit or the user input device.

The broadcast signal may further include an image signal, the method further including preventing the broadcast image signal from being displayed on the display unit if at least one of the image signal and the voice signal is received from the communication unit and the user input device.

### BRIEF DESCRIPTION OF DRAWINGS

The present invention will become apparent and more readily appreciated from the following description of the exemplary embodiments, taken in conjunction with the accompanying drawings, in which:

FIG. 1 is a television system according to an exemplary embodiment of the present invention;

FIG. 2 is a control block diagram of the television system according to an exemplary embodiment of the present invention;

FIG. 3 is a flowchart illustrating a control method of a television system according to an exemplary embodiment of the present invention; and

FIG. 4 is a control block diagram of a television system according to another exemplary embodiment of the present invention.

### DETAILED DESCRIPTION OF EXEMPLARY EMBODIMENTS

Reference will now be made in detail to the embodiments of the present invention, examples of which are illustrated in the accompanying drawings, wherein like reference numerals refer to like elements throughout. The exemplary embodiments are described below so as to explain the present invention by referring to the figures. Redundant description to different embodiments may be omitted as necessary.

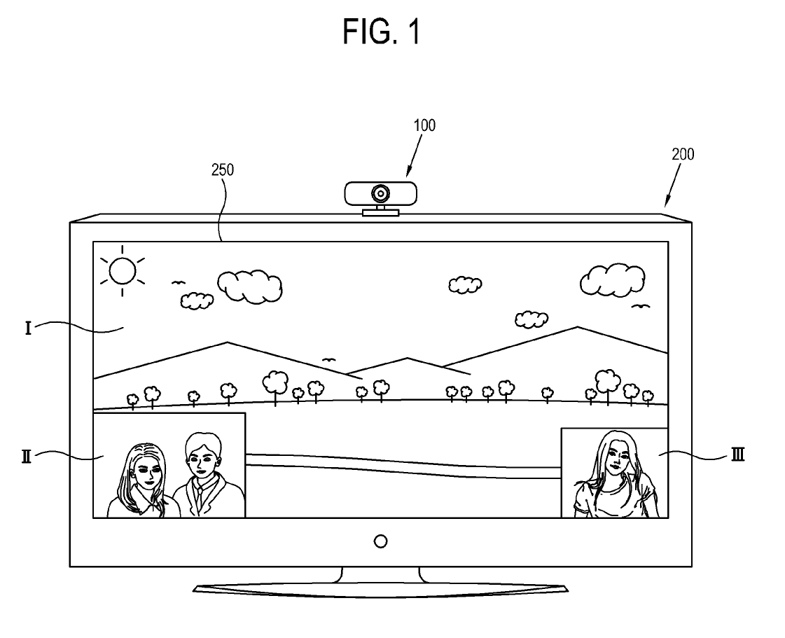

FIG. 1 illustrates a television system according to an exemplary embodiment of the present invention.

As shown in FIG. 1, the television system includes a user input device 100 and a signal processing apparatus 200. The signal processing apparatus 200 is embodied as a television including a tuner (not shown) which receives a broadcast signal.

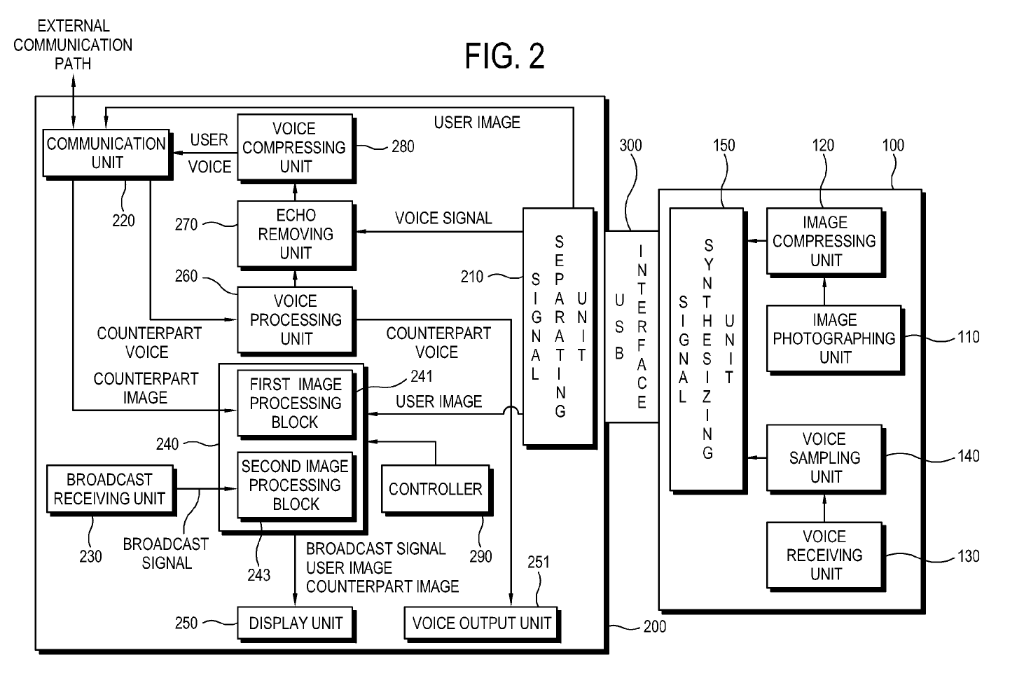

FIG. 2 is a control block diagram of the television system according to an exemplary embodiment of the present invention. The television system according to the present exemplary embodiment includes a communication unit 220 which is connected to a telephone network so that a user can communicate with at least one counterpart, and realizes video telephony using a display unit 250 in the television. The user input device 100 includes an image photographing unit 110 which photographs an image of the user and transmits the photographed image to the counterpart, and a voice receiving unit 130 which receives a voice of the user. The user input device and the signal processing apparatus 200 may be connected by a wired/wireless interface 300. According to the present exemplary embodiment, the user input device 100 and the signal processing apparatus 200 are connected each other by a USB interface. One of ordinary skill in the art will recognize that other wired/wireless interfaces may be used within the scope of the present invention.

As shown in FIG. 1, three types of images are displayed in the display unit 250 of the signal processing apparatus 200. The display unit 250 includes a broadcast portion I in which the broadcast signal is displayed; a user image portion II in which an image of the user is displayed; and at least one counterpart image portion III in which the image of the counterpart is displayed. In this way, the user may simultaneously view the counterpart image and the user image while watching the broadcast signal, thereby increasing utility of the television.

Referring back to FIG. 2, the user input device 100 includes the image photographing unit 110, an image compressing unit 120, a voice receiving unit 130, a voice sampling unit 140 and a signal synthesizing unit 150.

The image photographing unit 110 may include a camera as an image photographing element which photographs the user image, and an image signal processor (ISP) which processes the image signal photographed by the image photographing element. The photographed user image signal is displayed on the display unit 250 and transmitted to an external communication path through a communication unit 220.

The image compressing unit 120 compresses, that is, encodes the user image signal photographed by the image photographing unit 110 using a moving picture compression algorithm. The compressed user image signal is transmitted to the counterpart through the communication unit 220 and is simultaneously decoded by a controller 290 in the signal processing apparatus 200. In the television system according to the present exemplary embodiment, a configuration which compresses the user image signal is not included in the signal processing apparatus 200 but in the user input device 100, thereby reducing work load of the signal processing apparatus 200.

The voice receiving unit 130 may be embodied as a microphone through which the user inputs a voice signal. The voice receiving unit 130 may receive a voice of the user, but a voice of the counterpart output through a voice output unit 251 may be also input to the voice receiving unit 130. Hereinafter, the voice received through the voice receiving unit 130 is defined as a—voice signal. The voice signal includes the user voice signal and an acoustic sound signal such as the counterpart voice signal.

The voice sampling unit 140 performs a sampling which converts the user voice signal into a digital signal. The user voice signal is not compressed in the user input device 100, but is compressed after an echo is removed in the signal processing unit 200.

The signal synthesizing unit 150 synthesizes the user image signal compressed in the image compression unit 120 and the voice signal sampled in the voice sampling unit 140 for output to the signal processing apparatus 200. The synthesizing unit 150 may be embodied as a stream container and synchronizes the user image signal and the user voice signal in the signal synthesizing process. Time required for compressing the user image signal is different from time required for sampling the user voice signal. Accordingly, the signal synthesizing unit 150 synchronizes the user image signal and the user voice signal so that the user image and the user voice correspond to each other.

As described above, the user input apparatus 100 is connected to the signal processing apparatus 200 through a USB interface 300. That is, the user image signal and user voice signal output through the signal synthesizing unit 150 have a USB format. If the user input device 100 and the signal processing apparatus 200 are connected each other through an interface other than the USB interface 300, the image and voice signal output from the signal synthesizing unit 150 may be changed to be suitable for the corresponding interface format. In the case that the interface between the user input device 100 and the signal processing apparatus 200 is wireless, the user input device 100 and the signal processing apparatus 200 may further include a configuration which modulates and demodulates the signal for wireless communication.

The signal processing apparatus 200 includes a signal separating unit 210 which separates the synthesized image and voice signals; the communication unit 220 which receives the counterpart image signal and voice signal from an external communication path; and a broadcast receiving unit 230 which receives a broadcast signal. Further, the signal processing apparatus 200 includes an image processing unit 240 and a display unit 250; a voice processing unit 260, an echo removing unit 270, a voice compressing unit 280 and a voice output unit 251; and a controller 290 which controls the above components.

The signal separating unit 210 may be provided as a stream container like the signal synthesizing unit 150, and separates the signal stream from the user interface device into the user image signal and the voice signal. The user image signal separated from the signal separating unit 210, that is, the compressed user image signal, is supplied to the communication unit 220 and the image processing unit 240; and the voice signal is supplied to the echo removing unit 270.

The communication unit 220 receives an encoded counterpart image signal and an counterpart encoded voice signal through an external communication path, and transmits the user image signal and the user voice signal compressed in the image compressing unit 120 and the voice compressing unit 280, respectively, to the external communication path. The communication unit 220 may be a communication network including the Internet, an Ethernet host and a public switched telephone network, or may be a one-to-one network. Further, the communication unit 220 may include wired/wireless communication network.

The broadcast receiving unit 230 receives the broadcast signal including a broadcast image signal and a broadcast voice signal. The broadcast image signal is processed in a second image processing block 243 to be displayed on the display unit 250, and the broadcast voice signal is output through the voice output unit 251. The broadcast receiving unit 230 may include an antenna (not shown) and a tuner (not shown). The television system may further include a voice processing unit (not shown) which processes the voice signal of the broadcast signal for output to the voice output unit 251.

The image processing unit 240 includes two hardware decoders, that is, the first image processing block 241 and the second image processing block 243 which are physically independent processing blocks. The image processing unit 240 decodes input image signals using the image processing blocks and processes the image signals into a plurality of layers for output to the display unit 250.

The first image processing block 241 processes, that is, decodes the counterpart image signal received through the communication unit 220 to be displayed on the display unit 250. The second image processing block 243 processes the broadcast image signal received through the broadcast receiving unit 230 to be displayed on the display unit 250 as described above.

A method of decoding the image signals includes a method using an independent hardware decoder, and a method using a software decoder which performs operations under the control of the controller. The signal processing apparatus 200 according to the present exemplary embodiment processes the counterpart image signal and the broadcast image signal using the independent hardware decoders, and decodes the user image signal photographed with the image photographing unit 110 using the software decoder. The controller 290 according to the present exemplary embodiment is embodied as a central processing unit (CPU) which performs control of the signal processing apparatus 200; and the software decoder includes a JPEG decoder. That is, the user image signal is decoded through the JPEG decoder which performs decoding under the control of the CPU.

According to another exemplary embodiment, the controller 290 directly may decode the user image signal without using the JPEG decoder. The decoder of the user image signal may be changed according to a processing speed and a processing capability of the controller 290. Since three types of images are displayed using two hardware decoders and a software decoder, manufacturing cost of the television system is reduced. Further, the user can simultaneously view the user image and the counterpart image together with the broadcast image.

The image processing unit 240 synthesizes three types of image signals decoded through different routes for output to the display unit 250. In this respect, the broadcast image and the counterpart image processed in the image processing blocks 241 and 243 are processed into a first layer; and the user image is processed into a second layer which overlaps with the first layer. The image processing unit 240 synthesizes the image signals into different layers under the control of the controller 290 and then outputs the synthesized signal to the display unit 250. The first layer includes a low layer including video data, that is, a video layer, and the second layer includes a graphic layer such as an on screen display (OSD), a sub picture and a caption which overlay on the video layer. The controller 290 controls a portion of the graphic layer and transparency thereof.

The display unit 250 displays three types of images output from the image processing unit 240. The display unit 250 may include, for example, but not limited to, an LCD panel, an organic light emitting diode (OLED) panel or a plasma display panel (PDP), and includes a panel drive unit which drives the panels.

The controller 290 may control image compression rate or resolution of the image compressing unit 120 in consideration of a communication state of the communication unit 220 or a processing capability of the image processing unit 240. In this respect, a control signal therefor is output to the user input device 100 through the USB interface 300. The image compressing unit 120 of the user input device 100 may directly receive the control signal of the controller 290, or may indirectly receive the control signal through another controller (not shown) provided in the user input device 100.

The counterpart voice signal received through the communication unit 220 is input to the voice processing unit 260 for decoding. The decoded counterpart voice signal is output to the voice output unit 251 and the echo removing unit 270.

The voice output unit 251 outputs the counterpart voice for transmission to the user. The voice output unit 251 may include an amplifying circuit which amplifies the decoded counterpart voice signal, and a speaker which outputs the amplified voice signal.

As shown in FIG. 2, the echo removing unit 270 receives the voice signal from the signal separating unit 210 and receives the counterpart voice from the voice processing unit 260. The echo removing unit 270 removes the counterpart voice from the voice signal to obtain only the user voice. The counterpart voice signal output from the voice output unit 251 may be picked up by the television system through the voice receiving unit 130. In the case that the voice signal including the counterpart voice is transmitted to the counterpart, the counterpart hears his/her voice like an echo, thereby deteriorating communication quality. Thus, the echo removing unit 270 removes the counterpart voice included in the r voice signal to transmit only the user voice to the counterpart.

The user voice signal with the counterpart voice being removed is compressed in the voice compressing unit 280. The compressed user voice signal is transmitted to the counterpart together with the user image signal.

That is, the counterpart image signal received through the communication unit 220 is processed in the first processing block 241 for display, and the counterpart voice signal is processed in the voice processing unit 260 for output to the user. The user image signal is compressed by the image compressing unit 120 in the user input device 100 for transmission to the counterpart, and at the same time, is decoded by the controller 290 to be displayed on the display unit 250. The counterpart voice is removed from the voice signal in the signal processing apparatus 200, and the signal containing only the user voice is compressed to be transmitted to the counterpart.

In the case that communication is performed, that is, the counterpart voice signal is input through the communication unit 220, the user voice signal is input through the voice receiving unit 130, or the counterpart image signal or the user image signal is input while the broadcast signal is output through the display unit 250 and the voice output unit 251, the controller 290 blocks the voice signal of the broadcast signal from being output to the voice output unit 251, so as to prevent the broadcast voice signal from interrupting communication between the user and the counterpart. The controller 290 may include a switch which controls whether to output the voice signal included in the broadcast signal, or may include a switch which outputs one of the counterpart voice signal and the voice signal of the broadcast signal to the voice output unit 251. In this respect, the controller 290 may control the voice processing unit (not shown) which processes the voice signal of the broadcast signal and the voice processing unit 260 which processes the counterpart voice signal.

According to another exemplary embodiment of the present invention, the controller 290 may control the second image processing block 243 so that the broadcast image signal is not displayed on the display unit 250 in the case that the user attempts to communicate with the counterpart. That is, the controller 290 may block the broadcast image signal in addition to the voice signal of the broadcast signal, and thus, the user may focus on the video telephony. In this case, the sizes of the user image and the counterpart image may be automatically adjusted to fill a screen of the display unit 250.

Further, according to another exemplary embodiment of the present embodiment, the television system may further include a user selection unit (not shown) which sets and selects the type of the image displayed on the display unit 250. The user may not display the user image during communication or may not display the broadcast signal, through the user selection unit. Further, the user may adjust the sizes of image display portions I, II and III through the user selection unit.

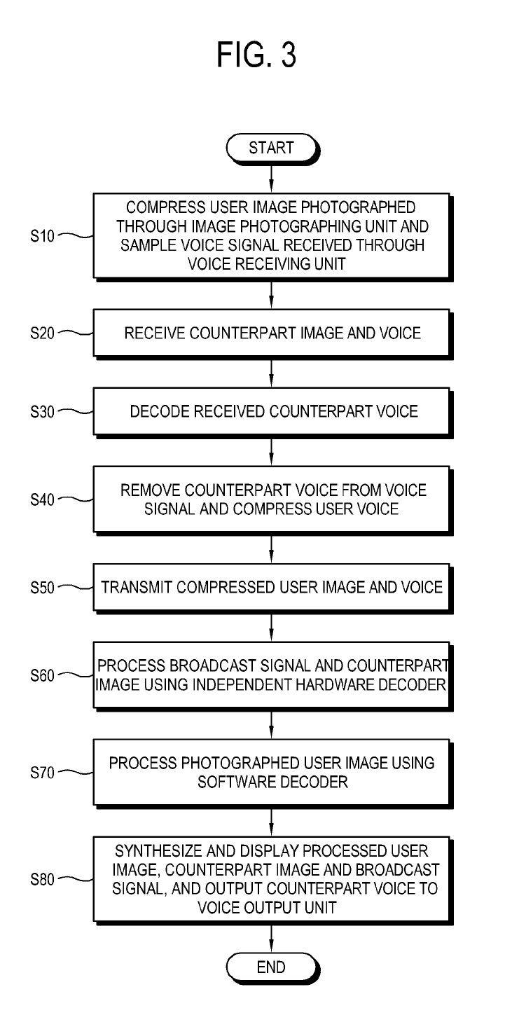

FIG. 3 is a flowchart illustrating a control method of a television system according to an exemplary embodiment of the present invention. A video telephony processing method using the television system will be described with reference to FIG. 3.

Firstly, the user input device 100 compresses the user image signal photographed through the image photographing unit 110 and samples the voice signal received through the voice receiving unit 130 (S10). The compressed user image signal and sampled voice signal are synchronized through the signal synthesizing unit 150 and then output to the signal processing unit 200.

On the other hand, the counterpart image signal and voice signal are received through the communication unit 220 (S20).

The received counterpart voice signal is decoded in the voice processing unit 260 (S30), and the decoded counterpart voice signal is input to the echo removing unit 270.

The echo removing unit 270 removes the counterpart voice from the voice signal input to the signal processing apparatus 200, and the user voice signal with the counterpart voice being removed is compressed in the voice compressing unit 280 (S40).

The compressed user image signal and the compressed user voice signal are transmitted to the counterpart through the communication unit 220 (S50).

The broadcast signal and the counterpart image signal are processed by independent hardware decoders such as the first image processing block 241 and the second image processing block 243 (S60), and the photographed user image signal is processed using a software decoder (S70).

The processed user image signal, the counterpart image signal and the broadcast image signal are synthesized by the image processing unit 240 into a video layer and a graphic layer to be displayed on the display unit 250, and the counterpart voice signal is output through the voice output unit 251 (S80).

In FIG. 3, the process that the user image signal and the user voice signal are transmitted to the counterpart is performed first, and the process that the counterpart voice signal and the counterpart image signal are output is performed later, is for simplicity of description. However, the received image and voice signals are simultaneously processed in real time. That is, the procedure in FIG. 3 is not limited to the illustrated sequence.

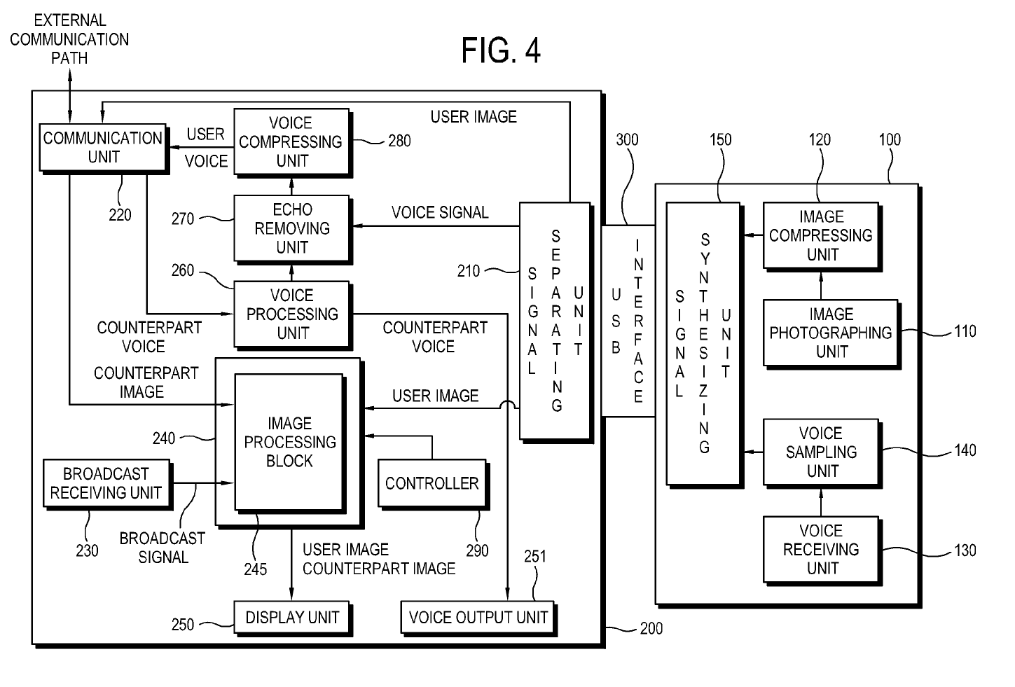

FIG. 4 is a control block diagram of a television system according to another exemplary embodiment of the present invention. As shown in FIG. 4, the television system includes an image processing block 245 in the image processing unit 240. The image processing block 245 may process the broadcast image signal and the counterpart image signal. In this case, the broadcast image signal input through the broadcast receiving unit 230 and the counterpart image signal input through the communication unit 220 may have the same image format. Although the image formats of the broadcast image signal and the counterpart image signal are different, the image processing block 245 may change the format of the input image signal into an image format which the image processing block 245 may process.

The image processing block 245 processes the broadcast image signal and displays the processed broadcast image signal on the display unit 250 at normal times. Then, if communication between the user and the counterpart begins, the image processing block 245 processes the counterpart image signal to display on the display unit 250. In this respect, the user image signal is processed by the controller 290 using the software decoder as described above and overlaps with the counterpart image for display.

As described above, the television system according to the present exemplary embodiment includes the hardware decoder and processes any one of the broadcast image signal and the counterpart image signal. When the counterpart image signal is processed, the user image signal is also processed by the software decoder. Accordingly, the manufacturing cost is reduced with one hardware decoder and a required image can be displayed as necessary.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A television system comprising:
a user input device; and
a signal processing apparatus,
wherein the user input device comprises:
an image photographing unit which photographs an image of a user and generates a user image signal; and
a voice receiving unit which receives a voice signal including a user voice signal, and
wherein the signal processing apparatus comprises:
a communication unit which receives an image signal and a voice signal of at least one counterpart from an external communication path, and transmits the user image signal and the user voice signal to the counterpart through the external communication path;
a voice processing unit which processes the received counterpart voice signal;
an image processing unit which comprises a first image processing block which processes the received counterpart image signal;
a voice output unit which receives the processed counterpart voice signal from the voice processing unit and outputs an counterpart voice;
a display unit; and
a controller which processes the user image signal using a software decoder, and controls the image processing unit so that the processed user image signal and the counterpart image signal are displayed on the display unit.

2. The television system according to claim 1, wherein the image processing unit processes the counterpart image signal into a first layer and processes the user image signal into a second layer which overlaps with the first layer.

3. The television system according to claim 2, wherein the first layer comprises a video layer, and the second layer comprises a graphic layer.

4. The television system according to claim 1, wherein the user input device further comprises a signal synthesizing unit which synchronizes the user image signal and the user voice signal, and
wherein the signal processing apparatus further comprises a signal separating unit which separates the user image signal from the user voice signal received from the signal synthesizing unit.

5. The television system according to claim 4, wherein the signal processing apparatus further comprises:
an echo removing unit which removes the counterpart voice from the voice signal received by the voice receiving unit; and
a voice compression unit which compresses the user voice signal output from the echo removing unit and outputs the compressed user voice signal to the communication unit.

6. The television system according to claim 1, wherein the user input device further comprises an image compression unit which compresses the user image signal.

7. The television system according to claim 1, wherein the signal processing apparatus further comprising a broadcast receiving unit which receives a broadcast signal comprising an image signal;
wherein the image processing unit further comprises a second image processing block which processes the image signal in the broadcast signal, and
wherein the controller controls the image processing unit so that the broadcast image signal is displayed on the display unit together with the counterpart image signal and the user image signal.

8. The television system according to claim 1, wherein the signal processing apparatus further comprising a broadcasting receiving unit which receives a broadcast signal comprising a voice signal,
wherein the controller prevents the voice signal in the broadcast signal from being output to the voice output unit if at least one of an image signal and a voice signal is received from the communication unit or the user input device.

9. The television system according to claim 8, wherein the broadcast signal further comprises an image signal,
the image processing unit further comprises a second image processing block which processes the image signal in the broadcast signal, and
the controller controls the second image processing block so that the image signal in the broadcast signal is not displayed on the display unit if at least one of the image signal and the voice signal is received from the communication unit or the user input device.

10. The television system according to claim 1, wherein the user input device and the signal processing apparatus are connected by a USB interface.

11. A control method of a television system which comprises an image photographing unit which photographs a user's image and generates a user image signal; a voice receiving unit which receives a voice signal including a user voice signal; a display unit; and a voice output unit, the control method comprising:
compressing the user image signal;
processing a received voice signal of at least one counterpart;
processing the compressed user image signal and the user voice signal for transmission to an external communication path;
processing a received image signal of the counterpart using a hardware decoder;
processing the user image signal using a software decoder;
synthesizing the processed user image signal and the counterpart image signal and displaying the synthesized image signals on the display unit, and outputting the processed counterpart voice signal to the voice output unit.

12. The control method according to claim 11, wherein the counterpart image signal is processed into a first layer and the user image signal is processed into a second layer which overlaps with the first layer, to be displayed on the display unit.

13. The control method according to claim 12, wherein the first layer comprises a video layer, and the second layer comprises a graphic layer.

14. The control method according to claim 11, wherein the transmitting the user voice signal to an external communication path comprises removing the counterpart voice from the voice signal received from the voice receiving unit.

15. The control method according to claim 11, wherein the television system further comprises a broadcast receiving unit which receives a broadcast signal comprising an image signal, the method further comprising:
processing the image signal in the broadcast signal using a hardware decoder different from the hardware decoder which processes the counterpart image signal, and
displaying the image signal in the broadcast signal on the display unit together with the counterpart image signal and the user image signal.

16. The control method according to claim 11, wherein the television system further comprises a broadcast receiving unit which receives a broadcast signal comprising a voice signal, and
wherein the method further comprises preventing the voice signal in the broadcast signal from being output to the voice output unit if at least one of the image signal and the voice signal is received from the communication unit or the user input device.

17. The control method according to claim 16, wherein the broadcast signal further comprises an image signal, and
wherein the method further comprising preventing the broadcast image signal from being displayed on the display unit if at least one of the image signal and the voice signal is received from the communication unit and the user input device.
